(19) United States
(12) Patent Application Publication
(10) Pub. No.: US 2014/0206399 A1
(43) Pub. Date: Jul. 24, 2014

(54) LOCATION-BASED GROUP GENERATION METHOD, APPARATUS AND SYSTEM

(71) Applicant: TENCENT TECHNOLOGY (SHENZHEN) COMPANY LIMITED, Shenzhen (CN)

(72) Inventor: Bo GUO, Shenzhen (CN)

(73) Assignee: TENCENT TECHNOLOGY (SHENZHEN) COMPANY LIMITED, Shenzhen (CN)

(21) Appl. No.: 14/222,809

(22) Filed: Mar. 24, 2014

Related U.S. Application Data
(63) Continuation of application No. PCT/CN2013/075282, filed on May 7, 2013.

(30) Foreign Application Priority Data
May 21, 2012 (CN) 201210157709.3

(51) Int. Cl. H04W 4/08; H04W 4/02

(52) U.S. Cl. CPC H04W 4/08; H04W 4/02
USPC 455/456.3

(57) ABSTRACT

The present disclosure discloses a location-based group generation method, apparatus and system. When a server in a mobile network in the present disclosure receives a group generation request that indicates a location area from a first mobile terminal, the server creates a group that includes the first mobile terminal and other mobile terminals in the location area. In this way, the present disclosure can create a group that includes the first mobile terminal and other mobile terminals in the location area of the first mobile terminal, and forward information in the group. When a user who uses the first mobile terminal sends information, the user is free from the trouble of sending the information to the terminals one by one, the use is simple and convenient, and the user experience is favorable.

### CROSS-REFERENCE TO RELATED APPLICATIONS

This application is a continuation application of PCT Patent Application No. PCT/CN2013/075282, entitled “LOCATION-BASED GROUP GENERATION METHOD, APPARATUS AND SYSTEM” filed on May 7, 2013, which claims priority to a Chinese Patent Application No. 201210157709.3, entitled “LOCATION-BASED GROUP GENERATION METHOD, APPARATUS AND SYSTEM” filed on May 21, 2012, both of which are incorporated by reference in their entirety.

### FIELD OF THE TECHNOLOGY

The present disclosure relates to the field of mobile communication and, in particular, to a location-based group generation method, apparatus and system.

### BACKGROUND OF THE DISCLOSURE

With development of the Internet technology, more and more applications can be implemented on a mobile terminal, which improves the user experience in using the mobile terminal. Such numerous applications include a positioning application, which is used to determine a location of a mobile terminal. The positioning application may adopt a Global Positioning System (GPS, Global Positioning System) to locate the mobile terminal. Specifically, a GPS module is set in a mobile terminal to determine the current location of the mobile terminal based on a mobile network. After the location of the mobile terminal has been determined, building information in the area where the mobile terminal resides may be obtained. The building information in each area may be pre-stored in a server of the mobile network, or the building information in a certain area is pre-downloaded to the mobile terminal. After determining the location of the mobile terminal by using the GPS module, the mobile terminal can obtain building information in the area around the location from the server, or obtain the building information in the corresponding area locally. Herein, buildings include restaurants, cinemas, and so on.

With the development of the positioning application in the Internet technologies, not only the building information in the area around the location point of a first mobile terminal can be obtained, but also other mobile terminals in the area around the location point of the

first mobile terminal can be located. The detailed solution is as follows: first, an identifier of a mobile terminal to be located is registered on a server of the mobile network, where the identifier may be an email box address, a username or a mobile network number of the mobile terminal; then, the mobile terminal to be located creates a link to the server of the mobile network, that is, the user who uses the mobile terminal to be located logs in to a network-side server of the mobile network; and then, the mobile terminal to be located uses a GPS module to determine its own location periodically, and reports the determined location and corresponding mobile terminal identifier to the server of the mobile network for storing; and finally, after one of the mobile terminals to be located determines its own location by using the GPS module, when this mobile terminal sends a request for acquiring information of other mobile terminals in the area around the location point of this mobile terminal to the server of the mobile network, according to the stored location information of other mobile terminals to be located, the server of the mobile network determines other mobile terminals to be located in the area around the location point of the mobile terminal that sends the request, and sends identifiers of the determined other mobile terminals to the mobile terminal that sends the request.

In this way, the mobile terminal that sends the request knows other mobile terminals to be located in the area around the location point of this mobile terminal, and, through the server of the mobile network, exchanges messages with other mobile terminals to be located in the area, for example, performs WeChat transmission, and so on.

However, although the foregoing solution can locate other mobile terminals in the area around the location point of the first mobile terminal, the messages are exchanged between the first mobile terminal and other mobile terminals in the area around the location point of the first mobile terminal in a point-to-point mode. When notifying information, the first mobile terminal notifies each of the other terminals in the area around the location point of the first mobile terminal in the point-to-point mode, respectively, which is rather complicated and leads to unfavorable experience of the user who uses the first mobile terminal.

### SUMMARY OF THE DISCLOSURE

Therefore, embodiments of the present disclosure provide a location-based group generation method to create a group that includes a first mobile terminal and other mobile terminals in a location area of the first mobile terminal.

Embodiments of the present disclosure further provide a location-based group generation apparatus to create a group that includes a first mobile terminal and other mobile terminals in a location area of the first mobile terminal.

Embodiments of the present disclosure further provide a location-based group generation system to create a group that includes a first mobile terminal and other mobile terminals in a location area of the first mobile terminal.

A location-based group generation method includes: storing, by a storage module using a processor in the non-transitory memory, mobile terminal location information corresponding to mobile terminal identifiers; receiving a group generation request indicating a location area from a first mobile terminal; determining, according to the stored mobile terminal location information, other mobile terminal identifiers in the location area indicated in the group generation request besides a first mobile terminal identifier; and setting the determined other mobile terminal identifiers and the first mobile terminal identifier into a group.

A location-based group generation system includes mobile terminals and a server, where the mobile terminals include a first mobile terminal and other mobile terminals, where: the first mobile terminal is configured to send a group generation request indicating a location area to the server; and the server is configured to: store, in a non-transitory memory, mobile terminal location information corresponding to mobile terminal identifiers, receive the group generation request indicating the location area from the first mobile terminal, determine, according to the stored mobile terminal location information, other mobile terminal identifiers in the location area indicated in the group generation request besides a first mobile terminal identifier, and set the determined other mobile terminal identifiers and the first mobile terminal identifier into a group.

A location-based group generation apparatus includes: a storage module using a processor and configured to store in a non-transitory memory mobile terminal location information corresponding to mobile terminal identifiers; a transceiver module using a processor and configured to receive a group generation request indicating a location area from a first mobile terminal and send the request; and a setting module using a processor and configured to: determine, according to the mobile terminal location information stored by the storage module, other mobile terminal identifiers in the location area indicated in the group generation request besides a first mobile terminal identifier, and set the determined other mobile terminal identifiers and the first mobile terminal identifier into a group.

As revealed in the above technical solution, when a server in a mobile network in the present disclosure receives a group generation request that indicates a location area from a first mobile terminal, the server creates a group that includes the first mobile terminal and other mobile terminals in the location area. In this way, the present disclosure can create a group that includes the first mobile terminal and other mobile terminals in the location area of the first mobile terminal, and forward information in the group. Therefore, when a user who uses the first mobile terminal sends information, the user is free from the trouble of sending the information to the terminals one by one, and thus the use is simple and convenient, and the user experience is favorable.

### BRIEF DESCRIPTION OF THE DRAWINGS

FIG. 1 is a flowchart of a location-based group generation method according to an embodiment of the present disclosure;

FIG. 2 is a schematic structural diagram of a location-based group generation system according to an embodiment of the present disclosure;

FIG. 3 is a schematic structural diagram of a location-based group generation apparatus according to an embodiment of the present disclosure; and

FIG. 4 is a detailed block diagram showing a structure of a server according to the embodiments of the present disclosure.

### DETAILED DESCRIPTION OF THE EMBODIMENTS

To make advantages of the technical solutions of the present disclosure more comprehensible, the following describes the present disclosure in detail with reference to accompanying drawings and embodiments of the present disclosure.

As revealed in the background description, when a user who uses a first mobile terminal sends a message, the user has to send the message to other mobile terminals in the location area of the first mobile terminal one by one, which is rather complicated and leads to unfavorable user experience. Therefore, the method, the system, and the apparatus provided in the present disclosure create a group on a server when the server of the mobile network receives a group generation request that indicates a location area from the first mobile terminal, where the group includes the first mobile terminal and other mobile terminals in the location area.

Further, when a group message that carries a group identifier and group information is received from a mobile terminal in the group, the server determines other mobile terminal identifiers in the group corresponding to the group identifier and sends the group information carried in the group message to other mobile terminals in the group.

In this way, the present disclosure can create a group that includes the first mobile terminal and other mobile terminals in the location area of the first mobile terminal, and forward information in the group.

In embodiments of the present disclosure, the “first mobile terminal” is so termed in order to discriminate it from other mobile terminals, but not to impose a special restriction on it. Any mobile terminal may send a group generation request, that is, any terminal may serve as the first mobile terminal.

In embodiments of the present disclosure, the location area includes a location point that is one of a geographic location of the first mobile terminal or a geographic location specified by the first mobile terminal, where the location area is a circular or rectangular area centered on the location point and extended to a set distance.

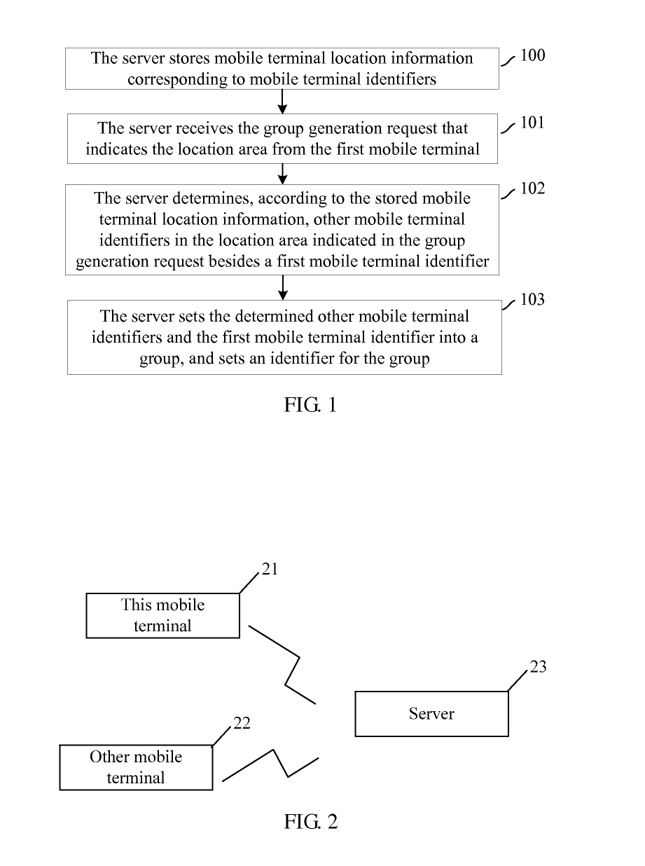

FIG. 1 is a flowchart of a location-based group generation method according to an embodiment of the present disclosure. The method includes the following steps.

Step 100: A server using a processor stores, in a non-transitory memory, mobile terminal location information corresponding to mobile terminal identifiers.

This step is performed by the server beforehand.

Step 101: The server receives a group generation request that indicates a location area from a first mobile terminal.

In this step, the first mobile terminal and other mobile terminals are all mobile terminals registered on the server. That is, as instructed by the server, after connecting to the server, the first mobile terminal and other mobile terminals report their own mobile terminal location information detected by themselves to the server periodically or at irregular intervals, and the server stores the mobile terminal location information corresponding to the mobile terminals into the non-transitory memory.

Step 102: According to the stored mobile terminal location information, the server determines other mobile terminal identifiers in the location area indicated in the group generation request besides a first mobile terminal identifier.

Because the first mobile terminal and other mobile terminals report their own mobile terminal location information to the server, the server knows the first mobile terminal and other mobile terminals that are located in the location area.

Step 103: The server sets the determined other mobile terminal identifiers and the first mobile terminal identifier into a group.

In this step, the first mobile terminal in the group may be identified as a group master. Further, the server may set a group identifier for the group.

By the examples as described above, the group is created.

After the group is created on the server, the server may send the group identifier to mobile terminals in the group.

Further, in FIG. 1, subsequent steps may include the following steps.

Step 104: The server receives a group message that carries the group identifier and group information from the mobile terminal.

Step 105: The server determines the group according to the group identifier, and sends the group information carried in the group message to mobile terminals in the corresponding group except the mobile terminal that sends the group message.

The first mobile terminal may download a map of the area around the location of the first mobile terminal from the server, and display the map on a user interface of the first mobile terminal. Before the first mobile terminal sends a group generation request that indicates a location area, the first mobile terminal receives the group generation request that indicates the location area and is input by the user through the user interface. For example, the user may use a touchscreen input mode or a character input mode to specify an area by drawing a rectangle or a circle or an irregular closed graph on the map, so as to search for other mobile terminals in the area, where the search area is a specified area or an area around a location point of the first mobile terminal, and is a circular or rectangular area centered on the location point of the first mobile or a geographic location specified by the first mobile terminal and extended to a set distance. The location point in the area may be a geographic location point of the first mobile terminal of the user (that is, the location point of the first mobile terminal), or a geographic location point specified by the user on the first mobile terminal by using a map or by other means.

In an embodiment of the present disclosure, after the server creates a group for the first mobile terminal, the first mobile terminal can perform group activities by sending a group message that carries the group identifier and group information. For example, when initiating a group activity, the first mobile terminal sends group information including a place, time, and content of the activity, and so on, so as to invite users of other mobile terminals in the group to join the activity; or when initiating a group session, the first mobile terminal sends group information including session content, so as to perform session interaction in the group. Other mobile terminals in the group may also perform a group activity by sending a group message.

In an embodiment of the present disclosure, the method further includes: the server receives a group message that carries a group identifier and group information from a mobile terminal other than the first mobile terminal that sends the group generation request; and the server determines a group corresponding to the group identifier, and sends the group information carried in the group message to mobile terminals in the group corresponding to the group identifier except the mobile terminal that sends the group message.

Here, any other mobile terminal may also be linked onto the server to obtain the group identifier of the group that includes the mobile terminal from the server, so as to send a group message in the group.

In an embodiment of the present disclosure, the method further includes: the server deletes a stored group corresponding to a group identifier carried in a group deletion message after receiving the group deletion message that carries the group identifier from the first mobile terminal.

Before the deletion, the server needs to determine whether the received group deletion message is a group deletion message sent by the first mobile terminal; and, if so, performs the deletion, or, if the group deletion message is sent by another mobile terminal in the group, the deletion is not performed.

FIG. 2 is a schematic structural diagram of a location-based group generation system according to an embodiment of the present disclosure. The system includes mobile terminals and a server 23, where the mobile terminals include a first mobile terminal (this mobile terminal) 21 and other mobile terminals 22, where: the first mobile terminal 21 is configured to send a group generation request that indicates a location area to the server 23. The server 23 is configured to: store mobile terminal location information corresponding to mobile terminal identifiers, receive the group generation request that indicates the location area from the first mobile terminal 21, determine, according to the stored mobile terminal location information, other mobile terminal identifiers in the location area indicated in the group generation request besides a first mobile terminal identifier, and set the determined other mobile terminal identifiers and the first mobile terminal identifier into a group.

In the system, the server 23 is further configured to assign a group identifier to the group and send the group identifier to mobile terminals in the group.

In the system, mobile terminals in the group are further configured to send and receive a group message that carries the group identifier and group information.

The server 23 is further configured to receive the group message that carries the group identifier and the group information from the mobile terminal in the group, determine the group corresponding to the group identifier, and send the group information carried in the group message to other mobile terminals 22 in the corresponding group.

In the system, the first mobile terminal 21 is further configured to send a group deletion message that carries a group identifier to the server 23.

The server 23 is further configured to receive the group deletion message that carries the group identifier from the first mobile terminal 21 and delete the group corresponding to the group identifier.

In the system, the mobile terminal location information stored in the server 23 is reported by the first mobile terminal 21 and other mobile terminals 22 as instructed by the server after the first mobile terminal 21 and other mobile terminals 22 perform a self detection respectively.

FIG. 3 is a schematic structural diagram of a location-based group generation apparatus according to an embodiment of the present disclosure. The apparatus is a server, including a setting module 31, a storage module 32, and a transceiver module 33, where: the storage module 32 is configured to store in a non-transitory memory mobile terminal location information corresponding to mobile terminal identifiers; the transceiver module 33 is configured to receive a group generation request that indicates a location area from a first mobile terminal and send the request to the setting module 31; and the setting module 31 is configured to: determine, according to the mobile terminal location information stored in the storage module 32, other mobile terminal identifiers in the location area carried in the group generation request besides a first mobile terminal identifier, and set the determined other mobile terminal identifiers and the identifier of the first mobile terminal into a group.

In the apparatus, the setting module 31 is further configured to assign a group identifier to the group and, the transceiver module 33 is further configured to send the group identifier to mobile terminals in the group.

In the apparatus, the transceiver module 33 is further configured to receive a group message that carries the group identifier and the group information from the mobile terminal in the group, determine a group corresponding to the group identifier in the setting module 31, and send the group information carried in the group message to the mobile terminals in the determined corresponding group corresponding to the group identifier except the mobile terminal that sends the group message.

The apparatus further includes a deleting module (not illustrated in the figure), which is configured to delete a group corresponding to a group identifier after the transceiver module receives a group deletion message that carries the group identifier from the first mobile terminal.

In the apparatus, the mobile terminal location information stored by storage module 32 is reported by the first mobile terminal and other mobile terminals through the transceiver module as instructed by the server after the first mobile terminal and other mobile terminals perform a self detection respectively.

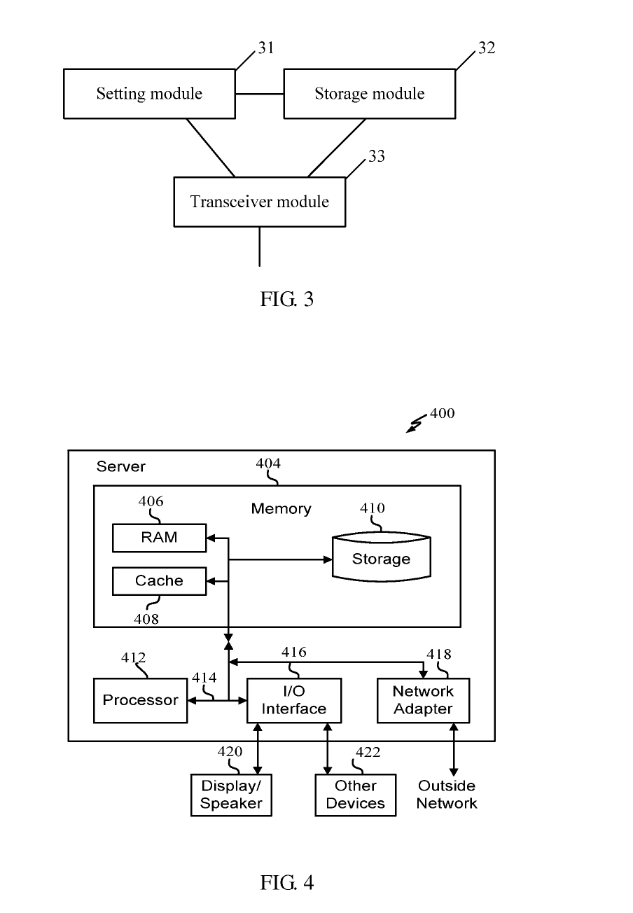

FIG. 4 is a detailed block diagram showing a structure of the server according to the embodiments of the present disclosure.

The server 400 shown in the FIG. 4 is only an exemplary server which is applicable to implement the embodiments of the present disclosure, which does not limit the functions and scopes of the embodiments of the present disclosure described herein. As shown in FIG. 4, the server 400 is shown in the form of a general-purpose computing device. The components of the server 400 may include, but are not limited to, one or more processors or processing units 412, a system memory 404, I/O interface 416, network adapter 418, display/speaker 420, other devices 422, and a bus 414 that couples various system components.

Bus 414 represents one or more of several types of bus structures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The server 400 typically includes a variety of computer system readable media. Such media may be any available media that is accessible by the server 12, and it includes both volatile and non-volatile media, removable and non-removable media.

System memory 404 can include computer system readable media in the form of volatile memory, such as random access memory (RAM) 406 and/or cache memory 408. The server 400 may further include other removable/non-removable, volatile/non-volatile computer system storage media. By way of example only, storage system 410 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 414 by one or more data media interfaces.

Memory 404 may include at least one program product having a set (e.g., at least one) of program modules which may be stored in storage system 410, by way of example, the program modules includes but not limited to the setting module 31, storage module 32, transceiver module 33 according to the embodiments of the present disclosure, which are configured to carry out the functions of embodiments of the present disclosure, as well as an operating system, one or more application programs, other program modules, and program data.

The server 400 may also communicate with one or more external devices 422 such as a keyboard, a pointing device, and a display/speaker 420, etc.; one or more devices that enable a user to interact with the server 400; and/or any devices (e.g., network card, modem, etc.) that enable the server 400 to communicate with one or more other computing devices. Such communication can occur via Input/Output (I/O) interfaces 416. Further, the server 400 can communicate with one or more networks such as a local area network (LAN), a general wide area network (WAN), and/or a public network (e.g., the Internet) via network adapter 418. The network adapter 418 communicates with the other components of the server 400 via bus 414.

With the method, system and apparatus provided in embodiments of the present disclosure, the user that uses the first mobile terminal can generate a group specific to a pertinent geographical area based on a location area. The user of the first mobile terminal in the group and the users of other mobile terminals can discuss issues that they are all interested in, or join an activity that they are all interested in, thereby improving the means of group collaboration, increasing flexibility of group collaboration, making it easier and more flexible to generate a group, and enhancing user experience and substantive communication.

The methods disclosed in embodiments of the present disclosure may be embodied in the form of a computer software product. The computer software product is stored in a storage medium, such as a floppy disk, a hard disk, or an optical disk of the computer, and contains several instructions used to instruct a computer device (for example, a personal computer, a server, or a network device) to perform the method disclosed in each embodiment of the present disclosure, or a universal hardware device is configured as a device of the present disclosure to implement the solution disclosed in each embodiment of the present disclosure. The universal hardware device may be a memory, such as a ROM/RAM, used for storing instructions, or may be a processor, such as a CPU, coupled with the memory and configured to execute the instructions stored in the memory.

The terminology used in the description of the disclosure herein is for the purpose of describing particular examples only and is not intended to be limiting of the disclosure. As used in the description of the disclosure and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

The foregoing descriptions are merely preferred embodiments of the present disclosure, but are not intended to limit the protection scope of the present disclosure. Any modifications, equivalent substitutions, and improvements made within the principles of the present disclosure shall fall within the protection scope of the present disclosure.

1. A location-based group generation method, comprising:
storing, by a storage module using a processor in a non-transitory memory, mobile terminal location information corresponding to mobile terminal identifiers;
receiving a group generation request indicating a location area from a first mobile terminal;
determining, according to the stored mobile terminal location information, other mobile terminal identifiers in the location area indicated in the group generation request besides a first mobile terminal identifier; and
setting the determined other mobile terminal identifiers and the first mobile terminal identifier into a group.

2. The method according to claim 1, wherein:
the mobile terminal location information is reported by mobile terminals after a self detection of the mobile terminals.

3. The method according to claim 1, wherein:
the location area includes a location point that is one of a geographic location of the first mobile terminal and a geographic location specified by the first mobile terminal.

4. The method according to claim 3, wherein:
the location area is one of a circular and a rectangular area centered on the location point and extended to a specific distance.

5. The method according to claim 1, further comprising:
assigning a group identifier to the group; and
sending the group identifier to mobile terminals in the group.

6. The method according to claim 1, further comprising:
receiving a group message that carries a group identifier and group information from a mobile terminal in the group;
determining a group corresponding to the group identifier; and
sending the group information carried in the group message to the mobile terminals in the group corresponding to the group identifier except the mobile terminal that sends the group message.

7. The method according to claim 1, further comprising:
receiving a group deletion message that carries the group identifier from the first mobile terminal; and
deleting the group corresponding to the group identifier.

8. A location-based group generation system, comprising mobile terminals and a server, wherein the mobile terminals comprise a first mobile terminal and other mobile terminals, wherein:
the first mobile terminal is configured to send a group generation request indicating a location area to the server; and
the server is configured to: store, in a non-transitory memory, mobile terminal location information corresponding to mobile terminal identifiers, receive the group generation request from the first mobile terminal, determine, according to the stored mobile terminal location information, other mobile terminal identifiers in the location area indicated in the group generation request besides a first mobile terminal identifier, and set the determined other mobile terminal identifiers and the first mobile terminal identifier into a group.

9. The system according to claim 8, wherein:
the server is further configured to assign a group identifier to the group, and send the group identifier to mobile terminals in the group.

10. The system according to claim 9, wherein:
mobile terminals in the group are further configured to send and receive a group message that carries the group identifier and group information; and
the server is further configured to receive the group message that carries the group identifier and the group information from the mobile terminal in the group, determine a group corresponding to the group identifier, and send the group information carried in the group message to the mobile terminals in the group corresponding to the group identifier except the mobile terminal that sends the group message.

11. The system according to claim 8, wherein:
the first mobile terminal is further configured to send a group deletion message that carries the group identifier to the server; and
the server is further configured to receive the group deletion message that carries the group identifier from the first mobile terminal, and delete the group corresponding to the group identifier.

12. A location-based group generation apparatus, comprising:
the storage module using a processor and configured to store, in a non-transitory memory, mobile terminal location information corresponding to mobile terminal identifiers;
the transceiver module using a processor and configured to receive a group generation request indicating a location area from a first mobile terminal and send the request; and
the setting module using a processor and configured to: determine, according to the mobile terminal location information stored by the storage module, other mobile terminal identifiers in the location area indicated in the group generation request besides a first mobile terminal identifier, and set the determined other mobile terminal identifiers and the first mobile terminal identifier into a group.

13. The apparatus according to claim 12, wherein:
the setting module is further configured to assign a group identifier to the group, and the transceiver module is further configured to send the group identifier to mobile terminals in the group.

14. The apparatus according to claim 12, wherein:
the transceiver module is further configured to receive a group message that carries the group identifier and the group information from a mobile terminal in the group, determine a group corresponding to the group identifier in the setting module, and send the group information carried in the group message to mobile terminals in the determined group corresponding to the group identifier except the mobile terminal that sends the group message.

15. The apparatus according to claim 12, further comprising:
a deleting module using a processor and configured to delete the group corresponding to the group identifier after the receiving module receives a group deletion message that carries the group identifier from the first mobile terminal.
